(19) United States
(12) Patent Application Publication
(10) Pub. No.: US 2004/0262334 A1
(43) Pub. Date: Dec. 30, 2004

(54) Multi-mode hard-candy, liquid-candy dispensing system

(76) Inventors: John Green, Abita Springs, LA (US); Paul Lapeyrouse JR., Mandeville, LA (US)

Correspondence Address: Carver, Darden, Koretzky, Tessier,, Finn, Blossman & Areaux L.L.C., Suite 2700, 1100 Poydras Street, New Orleans, LA, 70163, US

(21) Appl. No.: 10/837,520

(22) Filed: Apr. 29, 2004

Related U.S. Application Data
(63) Continuation-in-part of application No. 10/448,591, filed on May 30, 2003.
(60) Provisional application No. 60/385,479, filed on Jun. 3, 2002.

(51) Int. Cl. G01F 11/06; G01F 11/30

(52) U.S. Cl. 222/321.7

(57) ABSTRACT

A multi-mode hard-candy, liquid-candy dispensing system that includes a liquid-candy dispensing sprayer and container assembly that is adapted to be moved in multi-directions for fun and to permit better dispensing of the candy in children's mouths. The assembly includes an extendable and rotatable dispensing nozzle sprayer has a finger-actuated spray head to activate a fluid pumping unit. The sprayer also includes an elongated tube having one free end adapted to rotate 360° in a Y-plane with respect to and in fluid communication with the finger-actuated spray head. A dispensing nozzle is affixed to the other free end of the elongated tube. The hard-candy is molded to the nozzle for simultaneous and independent consumption and dispensing of the liquid-candy and hard-candy.

### CROSS-REFERENCE TO RELATED APPLICATIONS

The present invention claims priority benefit of pending U.S. non-provisional patent application having Ser. No. 10/448,591, filed May 30, 2003, incorporated herein by reference as if set forth in full below, and which also claims benefit of U.S. provisional patent application having Ser. No. 60/385,479 which was filed on Jun. 03, 2002.

### BACKGROUND OF THE INVENTION

1. Field of the Invention

The present invention relates to combination hard-candy, liquid candy dispensers and, more particularly, to a multi-mode hard-candy, liquid-candy dispensing system having a liquid-candy dispensing sprayer and container assembly that includes a 360° rotating, extended dispensing nozzle with hard-candy surrounding at least part of the nozzle for simultaneous and independent consumption and dispensing of both the liquid-candy and hard-candy.

2. General Background

Dispensing pumps that are small in size and finger-actuated are well known for use in atomizing perfumes, colognes and other personal care items, such as disclosed in U.S. Pat. No. 4,278,189, issued to Kirk, Jr., entitled “ACCUMULATIVE PRESSURE PUMP” which is incorporated herein by reference.

Breath refreshing solutions and candy have been dispensed through a sprayer nozzle as well. However, the finger-actuated nozzle head typically is easily removed by simply pulling the nozzle head off of the dispensing tube. This can be hazardous for the children's market since smaller children may swallow the nozzle head.

Additionally, this method of dispensing of a liquid candy has caused children to oftentimes miss their mouth and accidentally spray the candy in their eyes or elsewhere causing a mess.

Other dispensing pumps are described in U.S. Pat. No. 5,323,933, issued to Brakarz et al., entitled “ATOMIZER MICROPUMP FOR LIQUIDS” (which is incorporated herein by reference), which discloses a manually-operable liquid atomizer for spraying liquid.

With respect to hard-candy products, hard-candy that surrounds another edible, but different, candy is also known. For example, lollipops on a stick can have embedded gum or other edible substances. After you eat or break the hard-candy, the consumer can then access the embedded gum or other edible substance in the middle.

Moreover, various systems have been patented that are aimed at hard-candy and liquid-candy dispensing such as disclosed in U.S. Pat. No. 4,229,482, entitled “LOLLIPOP AND METHOD OF MAKING SAME”; U.S. Pat. No. 5,324,527, entitled “CANDY SUCKER AND LIQUID CANDY DISPENSING ASSEMBLY”; U.S. Pat. No. 6,187,352, entitled “CANDY-HOLDING AND LIQUID APPARATUS”; and, U.S. Pat. No. 6,565,899, entitled “COMBINATION LOLLIPOP, DRINKING STRAW AND BEVERAGE CAP”.

In view of the above, there is a continuing need for a hard-candy, liquid-candy dispensing system that includes a liquid-candy dispensing sprayer and container assembly that has a unitary, extendable, and rotatable dispensing-nozzle sprayer that can be rotated or swivel 360° to direct the spray in the mouth for independent dispensing of liquid-candy wherein the dispensing-nozzle is surrounded by hard-candy for independent consumption of the hard-candy and, alternately, simultaneous consumption during liquid-candy dispensing.

As will be seen more fully below, the present invention is substantially different in structure, methodology and approach from that of other combination hard-candy, liquid-candy dispensers.

### SUMMARY OF THE PRESENT INVENTION

The preferred embodiment of hard-candy, liquid-candy dispensing system of the present invention solves the aforementioned problems in a straight forward and simple manner.

Broadly, the present invention contemplates a multi-mode hard-candy, liquid-candy dispensing system comprising: liquid-candy; a liquid-candy dispensing sprayer and container assembly having a unitary, extendable, and rotatable dispensing-nozzle sprayer having a dispensing nozzle, the sprayer can be rotated or swivel 360° to direct spray in a mouth for independent dispensing of said liquid-candy from said dispensing nozzle, in a first mode; and, hard-candy molded and affixed to said dispensing nozzle for independent consumption of the hard-candy in a second mode and, alternately, simultaneous consumption during liquid-candy dispensing in a third mode.

The present invention contemplates a multi-mode hard-candy, liquid-candy dispensing system having an extendable and rotatable dispensing nozzle sprayer having a finger-actuated spray head to activate a pumping unit and which is in fluid communication with the pumping unit; an elongated tube having one free end adapted to rotate 360° in a Y-plane with respect to and in fluid communication with the finger-actuated spray head; and a dispensing nozzle coupled to the other free end of said elongated tube.

The present invention contemplates a multi-mode hard-candy, liquid-candy dispensing system having a liquid-candy dispensing sprayer and container assembly comprising: means for storing liquid candy therein having a longitudinal axis; means for pumping the liquid candy from the storing means; and, means for atomizing said liquid candy, said atomizing means comprises: means, which is finger-actuated, for actuating said pumping means and which is in fluid communication with said pumping means wherein said finger-actuated actuating means is adapted to be rotated 360° about said longitudinal axis, an elongated tube in fluid communication with said finger-actuated actuating means, means for rotatably coupling securely one free end of said elongated tube to said finger-actuated actuating means wherein said rotatably coupling means is adapted to rotate 360° along an axis which is essentially 90° displaced from the longitudinal axis, and means for dispensing said liquid candy which is securely coupled to the other free end of said elongated tube.

In view of the above, an object of the present invention is to provide a multi-mode hard-candy, liquid-candy dispensing system comprising a liquid-candy dispensing sprayer and container assembly that includes a finger-actuated nozzle head that is securely coupled to an elongated tube that can be rotated in multiple directions for fun when used.

Another object of the present invention is to provide a multi-mode hard-candy, liquid-candy dispensing system comprising a liquid-candy dispensing sprayer and container assembly that has an improved delivery system for dispensing the liquid candy in the mouth of the user and minimize accidentally spraying of the liquid candy in their eyes or elsewhere causing a mess.

Another object of the present invention is to provide a multi-mode hard-candy, liquid-candy dispensing system comprising a liquid-candy dispensing sprayer and container assembly that has an improved delivery system for dispensing the liquid candy in the mouth of the user while being safe for use by children.

In view of the above objects, it is a feature of the present invention to provide a multi-mode hard-candy, liquid-candy dispensing system that is simple to use even by children.

Another feature of the present invention is to provide a multi-mode hard-candy, liquid-candy dispensing system that is relatively simple structurally and thus simple to manufacture.

A still further object of the present invention is to provide a multi-mode hard-candy, liquid-candy dispensing system comprising a liquid-candy dispensing sprayer and container assembly that is made of transparent material to view the liquid candy.

A still further object of the present invention is to provide a multi-mode hard-candy, liquid-candy dispensing system comprising hard-candy that is made of transparent material.

The above and other objects and features of the present invention will become apparent from the drawings, the description given herein, and the appended claims.

### BRIEF DESCRIPTION OF THE DRAWING

For a further understanding of the nature and objects of the present invention, reference should be had to the following description taken in conjunction with the accompanying drawings in which like parts are given like reference numerals and, wherein:

FIG. 1 illustrates a perspective view of the multi-mode hard-candy, liquid-candy dispensing system of the present invention with the extendable and rotatable dispensing nozzle sprayer rotated to two different rotations (approximately a 180° location and a 315° location);

FIG. 2 illustrates a perspective view of the multi-mode hard-candy, liquid-candy dispensing system of the present invention with the extendable and rotatable dispensing nozzle sprayer rotated to a 270° location;

FIG. 3 illustrates a side view of the multi-mode hard-candy, liquid-candy dispensing system with the extendable and rotatable dispensing nozzle sprayer rotated to a 270° location and having liquid candy therein;

FIG. 4 illustrates a front view of the multi-mode hard-candy, liquid-candy dispensing system of the present invention with the extendable and rotatable dispensing nozzle sprayer rotated to a 270° location;

FIG. 5 illustrates an exploded view of an alternate embodiment of the extendable and rotatable dispensing nozzle sprayer with the hard-candy surround; and,

FIG. 6 illustrates a cross-sectional view of the hard-candy surround.

### DETAILED DESCRIPTION OF THE PREFERRED EMBODIMENT

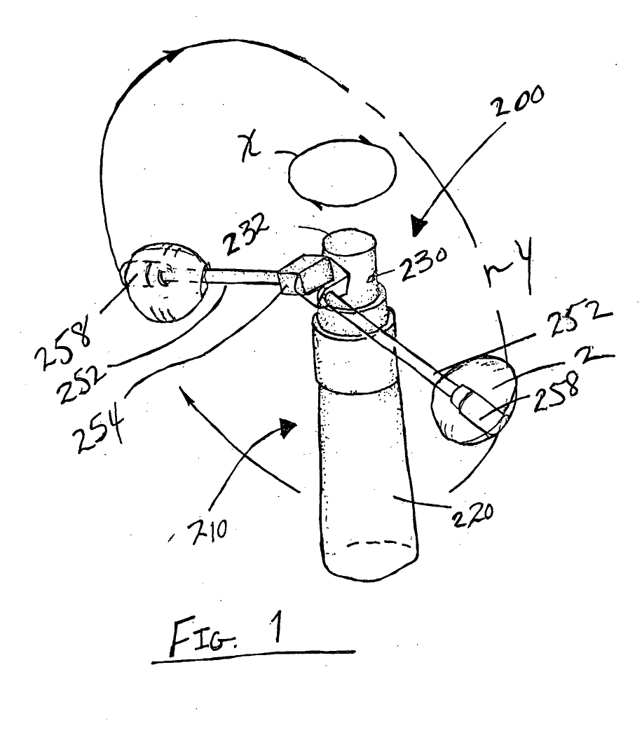

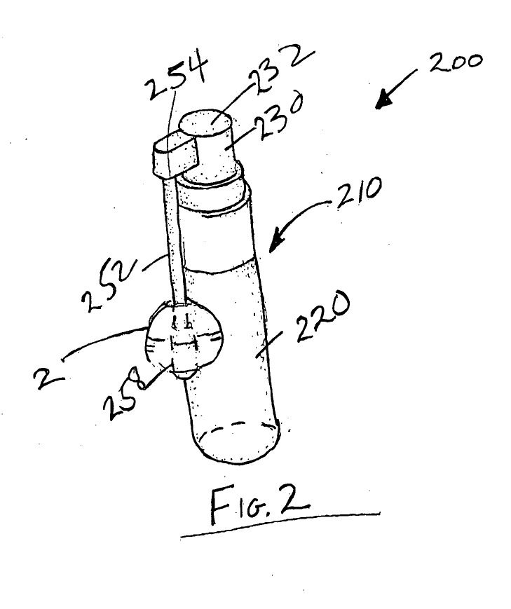

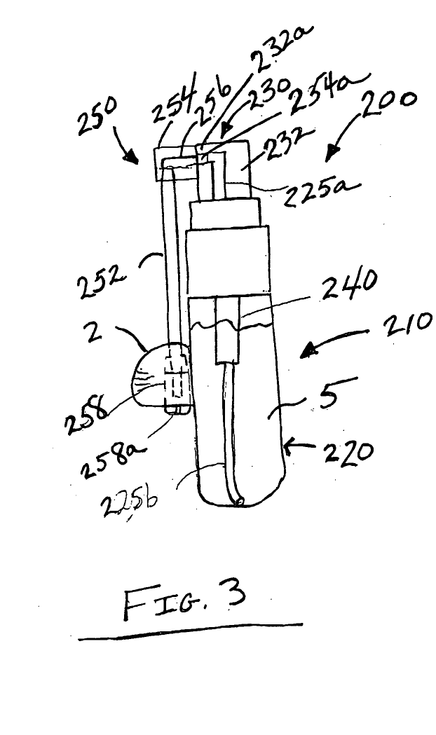

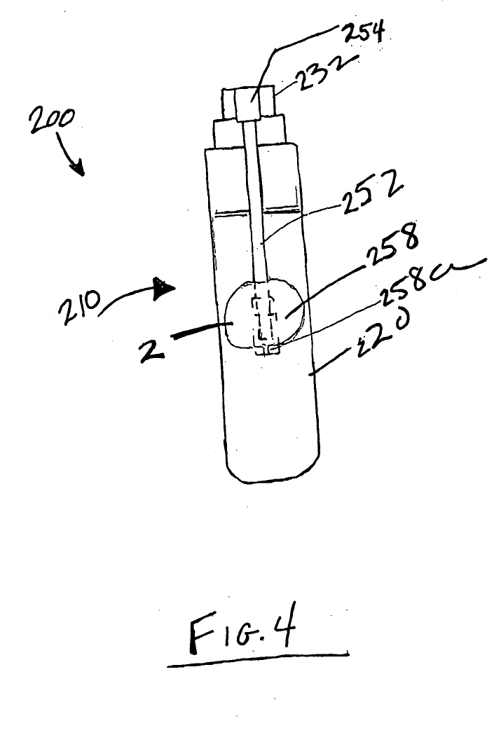

Referring now to the drawings and in particular FIGS. 1-4, the multi-mode hard-candy, liquid-candy dispensing system of the present invention is generally referenced by the numeral 200. The multi-mode hard-candy, liquid-candy dispensing system 200 marries both hard-candy 2 and liquid-candy dispensing and consumption so that both can take place simultaneously and independently. The hard-candy, liquid-candy dispensing system 200 includes a liquid-candy dispensing sprayer and container assembly 210 that has a unitary, extendable, and rotatable dispensing-nozzle sprayer 230 that can be rotated or swivel 360° to direct the spray in the mouth for independent dispensing of liquid-candy (mode 1) from a dispensing nozzle 258. The dispensing nozzle 258 is surrounded by hard-candy for independent consumption of the hard-candy (mode 2) and, alternately, simultaneous consumption during liquid-candy dispensing (mode 3). As can be appreciated, all three modes take place (provided neither or both of the hard-candy and liquid-candy are fully consumed) without the removal of the unitary, extendable, and rotatable dispensing-nozzle sprayer 230 from the system 200.

During consumption of the hard-candy 2 and liquid-candy 5, whether simultaneously or independently, the multi-directional rotation of the extendable and rotatable dispensing nozzle sprayer 230 provides for fun when used by children and provides a more accurate and safe delivery system for the liquid-candy 5.

The specific details related to liquid-candy dispensing and the dispensing sprayer and container assembly 210 is described below. The dispensing sprayer and container assembly 210 includes an extendable and rotatable dispensing nozzle sprayer 230 having a finger-actuated spray head 232 in fluid communication via an upper tube 225a coupled to a pumping unit 240. The pumping unit 240 is disposed in the container 220 and has coupled thereto lower dip tube 225b to channel the liquid-candy 5 in the container 220 up to the finger-actuated spray head 232 via the pumping unit 240.

Conventionally, the finger-actuated spray head 232 includes an orifice to atomize and dispense the fluid at approximately 90° with respect to the dispensing tubes 225a and 225b. The extendable and rotatable dispensing nozzle sprayer 230 further includes an extension dispensing tube/atomizer 250 rotatably coupled to the finger-actuated spray head 232 at a location that is approximately 90° with respect to the fluid communication path defined by the upper tube 225a and dispensing tube 225b. The finger-actuated spray head 232 is adapted to be rotated 360° in the X-plane or with respect to the longitudinal axis of the container 220. The X-plane is essentially 90° displaced from the Y-plane. In the preferred embodiment, the finger-actuated spray head 232 may be continually rotated clockwise and, alternately, counterclockwise about a top of container 220.

In the exemplary embodiment, the pumping unit 240 is a spring-operated ball-valve pumping unit that is small in size and lightweight. The pumping unit 240 is well known in the art. Thus, no further description is necessary. Nevertheless, other pumping units may be employed such as those used to atomize a liquid via a finger-actuated spray head.

The extension dispensing tube/atomizer 250 includes an elongated tube 252 having one free end rotatably coupled to the finger-actuated spray head 232 via a secure male connector 254 that allows the elongated tube 252 to be rotated 360° in the Y-plane, as best seen in FIG. 1, about the finger-actuated spray head 232. The elongated tube 252 is in fluid communication with the finger-actuated spray head 232 such that the flow of the liquid-candy 5 being dispensed flows from the container through the tubes 225a and 225b and into the elongated tube 252 via a fluid channel 256 within the secure male connector 254.

The other free end of the elongated tube 252 has affixed thereto a dispensing nozzle 258 having an orifice 258a therein that atomizes the liquid-candy 5 flowing through the other free end of the elongated tube 252. In the preferred embodiment, the dispensing nozzle 258 receives air so that the liquid-candy 5 can be sprayed into a mist out through orifice 258a, especially, when pumped quickly.

In the exemplary embodiment, the secure male connector 254 includes a male coupler 254a adapted to be securely snapped fit within the mated female counterpart 232a within the finger-actuated spray head 232. The secure snapped fit may include one or more ridge/groove combinations. An increase in ridge/groove combinations improves the security. For example, one or more ridge/groove combinations may be used to connect the nozzle 258 to elongated tube 252. Moreover, the other end of the elongated tube 252 may also include one or more ridge/groove combinations to connect to male connector 254.

In the preferred embodiment, the snapped fit between the secure male connector 254 and the finger-actuated spray head 232 is not easily removed so that the extendable and rotatable dispensing nozzle sprayer 230 remains a unitary structure.

In the preferred embodiment, the container 220, finger-actuated spray head 232 and elongated tube 252 are made of transparent plastic material or other transparent material so that the user can determine the level of and visually see the liquid-candy 5 in container 220. Furthermore, in the preferred embodiment, the container 220 and finger-actuated spray head 232 are colored such as with a variety of colors which may have neon-type properties. Furthermore, depending on the flavor of the liquid candy, the liquid candy may also be colored to add to the overall entertainment of the product. Various flavors of the liquid candy include strawberry, other sour citrus or fruit flavors, etc.

The container 220 may be colored different from the finger-actuated spray head 232. The dispensing nozzle 258 may have the same color as the finger-actuated spray head 232 or a different color.

In the exemplary embodiment, container 220 is cylindrically-shaped with a diameter of approximately ⅝ inch. The length from the top of the finger-actuated spray head 232 in a non-pressed state to the bottom of container 220 is approximately 4 inches.

The unitary structure of the extendable and rotatable dispensing nozzle sprayer 230 provides an additional safety feature in that it is not a small choking hazard as is a single finger-actuated spray head 232.

Now with regard to hard-candy dispensing, the hard-candy 2 is molded edible material such as a lollipop, sucker in the form of a truncated sphere, as best seen in FIG. 6. The hard-candy 2 surrounds both the dispensing nozzle 258 (SHOWN IN PHANTOM) and the bottom end of the elongated tube 252. However, the orifice 258a in the dispensing nozzle 258 remains unobstructed by the hard-candy 2 so that liquid-candy 5 can be dispensed independently of the consumption of the hand-candy 2. In the exemplary embodiment, the hard-candy 2 is transparent such that the dispensing nozzle 258 is seen.

In an alternate embodiment, the hard-candy 2 may completely surround the dispensing nozzle 258 such that the orifice 258a is covered with a thin layer of hard-candy 2 that dissolves in the mouth or can be removed with consumption whether licking, bitting, etc.

As can be appreciated, the hard-candy 2 can be eaten independently (mode 2) of the liquid-candy 5 in a manner similar to a lollipop or sucker or simultaneously (mode 3) with the spraying of liquid-candy 5.

While, the description herein describes the hard-candy 2 as being a truncated sphere, other geometric shapes may be substituted. For example, a full sphere could be used provided the length of male connector 254 is increased. Furthermore, the hard-candy 2 since mounted on elongated tube 252 is adapted to be rotated 360° in the X plane or with respect to the longitudinal axis of the container 220, as best seen in FIG. 1.

The sphere of the hard-candy 2 can also have embedded design or pattern such that the sphere surface resembles the shape of a basketball, baseball, football, soccer ball, etc. Furthermore, the shape can be designed for other entertaining characters or symbols.

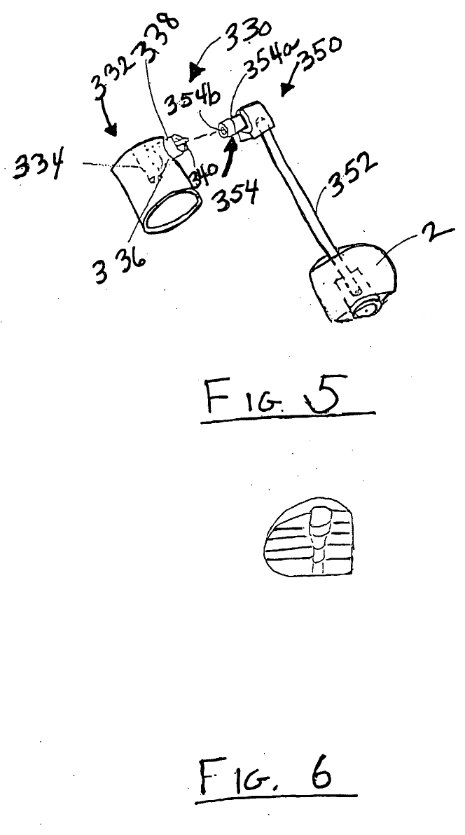

Referring now to FIG. 5, an alternate embodiment of the extendable and rotatable dispensing nozzle sprayer 330 is shown. The extension dispensing tube/atomizer 350 includes an elongated tube 352 having one free end rotatably coupled to the finger-actuated spray head 332 via a first secure male connector 354 that allows the elongated tube 352 to be rotated 360° in the Y-plane, about the finger-actuated spray head 332.

In the exemplary embodiment, the first secure male connector 354 is a tubular member having an annular groove 354a formed around the perimeter. The interior 354b of the tubular member is hollow to permit the flow of fluid therethrough and is dimensioned to friction fit couple therein a second male connector 340.

The finger-actuated spray head 332 includes a central tubular member 334 which is aligned with the longitudinal axis of container 220 and connects to tube 225a for the communication of the liquid-candy 5. Central tubular member 334 has an orifice 336 positioned approximately 90° with respect to the longitudinal axis of container 220. Such orifice 336 includes a first tubular member 338 and a second male connector 340 (which is another tubular member) concentrically disposed within the first tubular member 338 and extends beyond the edge of the first tubular member 438. The first male connector 354 receives the second male connector 340 within its hollow interior 354b while the first male connector 354 is received between the first tubular member 338 and the second male connector 340. The first tubular member 338 includes an annular ridge to engage the annular groove 354a. Accordingly, the first male connector 354 is adapted to be securely snapped fit within the first tubular member 338 (serving as a mated female counterpart) and rotate 360°.

This arrangement between the first male connector 354, the first tubular member 338 and the second male connector 340 provides an improved secure snapped fit of the extension dispensing tube/atomizer 350 to the finger-actuated spray head 332 so that it is not easily removed and the extendable and rotatable dispensing nozzle sprayer 330 remains a unitary structure with rotatable capabilities.

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

What is claimed as invention is:

1. A hard-candy, liquid-candy dispensing system comprising:
a liquid-candy dispensing sprayer and container assembly including:
a container for storing liquid candy therein, with liquid candy stored therein,
a pumping unit to pump the liquid-candy from the container via a dip tube, and
an extendable and rotatable dispensing nozzle sprayer having a finger-actuated spray head to activate said pumping unit and which is in fluid communication with the pumping unit, an elongated tube having one free end adapted to rotate 360° in a Y-plane with respect to and in fluid communication with said finger-actuated spray head, and a dispensing nozzle coupled to the other free end of said elongated tube; and,
hard-candy molded around and affixed to a portion of said elongated tube and said dispensing nozzle wherein dispensing of said liquid-candy and consumption of said hard-candy are both adapted to take place simultaneously and wherein dispensing of said liquid-candy and consumption of said hard-candy are each adapted to take place independently.

2. The system of claim 1, wherein said hard-candy has a semi-spherical shape.

3. The system of claim 1, wherein said hard-candy resembles one of a basketball, soccerball, and baseball.

4. The system of claim 1, wherein:
said container is made of transparent material; and,
said hard-candy is transparent.

5. The system of claim 4, wherein said extendable and rotatable dispensing nozzle sprayer is made of transparent material.

6. The system of claim 1, wherein said dispensing nozzle atomizes said liquid candy therefrom in a form of a mist.

7. The system of claim 1, wherein the extendable and rotatable dispensing nozzle sprayer is essentially a unitary structure.

8. The system of claim 1, wherein said finger-actuated spray head is adapted to be rotated 360° in an X-plane which is essentially 90° displaced from the Y-plane.

9. The system of claim 1, wherein:
said container is cylindrically-shaped with a diameter of approximately ⅝ inch; and,
said assembly has a length of approximately 4 inches from a top of the finger-actuated spray head, in a non-pressed state, to a bottom of said container.

10. The system of claim 1, wherein:
said finger-actuated spray head includes a center tubular member aligned with a longitudinal axis of said container, and an orifice displaced approximately 90° with respect to the longitudinal axis, wherein said orifice includes a first tubular member and a second tubular member concentrically disposed in said first tubular member; and,
further comprising:
a third tubular member adapted to be securely snapped fit between the first tubular member and the second tubular member wherein the snapped fit allows for 360° rotation of said third tubular member;
said third tubular member coupled to said one free end of said elongated tube.

11. The system of claim 1, wherein:
said liquid-candy dispensing sprayer and container assembly is made of transparent material; and,
said hard-candy is transparent.

12. A multi-mode hard-candy, liquid-candy dispensing system comprising:
a liquid-candy dispensing sprayer and container assembly comprising:
a container for storing liquid candy therein,
a pumping unit to pump the liquid-candy from the container via a dip tube and,
an extendable and rotatable dispensing nozzle sprayer having a finger-actuated spray head to activate said pumping unit and which is in fluid communication with the pumping unit, a rotatable coupler coupled to said finger-actuated spray via a secure snap-on connection, an elongated tube having one free end adapted to rotate 360° in a Y-plane with respect to and in fluid communication with said finger-actuated spray head via said rotatable coupler, and a dispensing nozzle securely coupled to the other free end of said elongated tube; and
hard-candy molded around and affixed to a portion of said elongated tube and said dispensing nozzle wherein dispensing of said liquid-candy and consumption of said hard-candy are both adapted to take place simultaneously and wherein dispensing of said liquid-candy and consumption of said hard-candy are each adapted to take place independently.

13. The system of claim 12, wherein said hard-candy has a semi-spherical shape.

14. The system of claim 12, wherein said hard-candy resembles one of a baseball, soccerball, and basketball.

15. The system of claim 12, wherein:
said container is made of transparent material; and,
said hard-candy is transparent.

16. The system of claim 12, wherein:
said liquid-candy dispensing sprayer and container assembly is made of transparent material; and,
said hard-candy is transparent.

17. The system of claim 12, wherein said container is made of transparent material.

18. The system of claim 12, wherein said extendable and rotatable dispensing nozzle sprayer is made of transparent material.

19. The system of claim 12, wherein said dispensing nozzle atomizes said liquid candy therefrom in a form of a mist.

20. The system of claim 12, wherein the extendable and rotatable dispensing nozzle sprayer is essentially a unitary structure.

21. The system of claim 12, wherein said finger-actuated spray head is adapted to be rotated 360° in an X-plane which is essentially 90° displaced from the Y-plane.

22. The system of claim 12, wherein said container and said extendable and rotatable dispensing nozzle sprayer are made of transparent plastic material of different colors.

23. The system of claim 12, wherein:
said container is cylindrically-shaped with a diameter of approximately ⅝ inch; and,
said assembly has a length of approximately 4 inches from a top of the finger-actuated spray head, in a non-pressed state, to a bottom of said container.

24. The assembly of claim 12, wherein:
said finger-actuated spray head includes a center tubular member aligned with a longitudinal axis of said container, and an orifice displaced approximately 90° with respect to the longitudinal axis, wherein said orifice includes a first tubular member and a second tubular member concentrically disposed in said first tubular member; and,
said rotatable coupler comprises:
a third tubular member adapted to be securely snapped fit between the first tubular member and the second tubular member wherein the snapped fit allows for 360° rotation of said third tubular member;
said third tubular member coupled to said one free end of said elongated tube.

25. An extendable and rotatable dispensing nozzle sprayer for dispensing liquid candy comprising:
a finger-actuated spray head to activate a fluid pumping unit and which is in fluid communication with the pumping unit;
an elongated tube having one free end adapted to rotate 360° in a Y-plane with respect to and in fluid communication with said finger-actuated spray head via a secure rotatable coupling;
a dispensing nozzle securely coupled the other free end of said elongated tube for atomizing said liquid candy;
hard-candy molded around at least a portion of said dispensing nozzle.

26. The sprayer of claim 25, wherein the finger-actuated spray head, said elongated tube and said dispensing nozzle are constructed and arranged to form a unitary structure.

27. The sprayer of claim 25, wherein said finger-actuated spray head is adapted to be rotated 360° in an X-plane which is essentially 90° displaced from the Y-plane.

28. The sprayer of claim 25, wherein said finger-actuated spray head, said elongated tube and said dispensing nozzle are made of transparent plastic material.

29. The sprayer of claim 28, wherein said hard-candy is transparent.

30. The sprayer of claim 25, wherein:
said finger-actuated spray head includes a center tubular member aligned with a first axis, and an orifice displaced approximately 90° with respect to the first axis, wherein said orifice includes a first tubular member and a second tubular member concentrically disposed in said first tubular member; and,
said secure rotatable coupling comprises:
a third tubular member adapted to be snapped fit between the first tubular member and the second tubular member wherein the snapped fit allows for 360° rotation of said third tubular member;
said third tubular member coupled to said one free end of said elongated tube.

31. The sprayer of claim 25, wherein said hard-candy has a semi-spherical shape.

32. The sprayer of claim 25, wherein said hard-candy resembles one of a baseball, soccerball, and basketball.

33. A multi-mode hard-candy, liquid-candy dispensing system comprising:
means for storing liquid-candy therein having a longitudinal axis with liquid candy stored in said means for storing;
means for pumping the liquid-candy from the storing means;
means for atomizing said liquid-candy, said atomizing means comprises:
means, which is finger-actuated, for actuating said pumping means and which is in fluid communication with said pumping means wherein said finger-actuated actuating means is adapted to be rotated 360° about said longitudinal axis,
an elongated tube in fluid communication with said finger-actuated actuating means,
means for rotatably coupling securely one free end of said elongated tube to said finger-actuated actuating means wherein said rotatably coupling means is adapted to rotate 360° along an axis which is essentially 90° displaced from the longitudinal axis, and
means for dispensing said liquid-candy which is securely coupled to the other free end of said elongated tube; and,
hard-candy surrounding at least part of said dispensing means.

34. The system of claim 33, wherein said storing means is made of transparent material.

35. The system of claim 33, wherein said atomizing means is made of transparent material.

36. The system of claim 33, wherein said dispensing means atomizes said liquid candy therefrom in a form of a mist.

37. The system of claim 33, wherein the atomizing means is essentially a unitary structure.

38. The system of claim 33, wherein said finger-actuated actuating means is adapted to be continually rotated clockwise and, alternately, counterclockwise about a top of said storing means.

39. The system of claim 33, wherein said storing means and said atomizing means are made of transparent plastic material of different colors.

40. The system of claim 39, wherein:
said storing means is cylindrically-shaped with a diameter of approximately ⅝ inch; and,
said assembly has a length of approximately 4 inches from a top of the finger-actuated actuating means, in a non-pressed state, to a bottom of said storing means.

41. The system of claim 33, wherein:
said finger-actuated actuating means includes a center tubular member aligned with said longitudinal axis of said storing means, and an orifice displaced approximately 90° with respect to the longitudinal axis, wherein said orifice includes a first tubular member and a second tubular member concentrically disposed in said first tubular member; and,
said rotatable coupling means comprises:
a third tubular member adapted to be securely snapped fit between the first tubular member and the second tubular member wherein the snapped fit allows for 360° rotation of said third tubular member;
said third tubular member coupled to said one free end of said elongated tube.

42. The system or claim 33, wherein said hard-candy has a semi-spherical shape.

43. The system of claim 33, wherein said hard-candy resembles one of a baseball, soccerball, and basketball.

44. A multi-mode hard-candy, liquid-candy dispensing system comprising:
liquid-candy in a hand-held container;
a liquid-candy dispensing sprayer and container assembly operably mounted to said container having a unitary, extendable, and rotatable dispensing-nozzle sprayer having a dispensing nozzle, said sprayer can be rotated or swivel 360° to direct spray in a mouth for independent dispensing of said liquid-candy from said dispensing nozzle, in a first mode; and,
hard-candy molded and affixed to said dispensing nozzle for independent consumption of the hard-candy in a second mode and, alternately, simultaneous consumption during liquid-candy dispensing in a third mode.

45. The system of claim 44, wherein said hard-candy has a semi-spherical shape.

46. The system of claim 44, wherein said hard-candy resembles one of a baseball, soccerball, and basketball.

47. The system of claim 44, wherein said hard-candy is transparent.

48. The system of claim 44, wherein said first mode, said second mode and said third mode take place, provided neither or both of the hard-candy and the liquid-candy are fully consumed, without the removal of the unitary, extendable, and rotatable dispensing-nozzle sprayer from the liquid-candy dispensing sprayer and container assembly.
